(19) United States
(12) Patent Application Publication
(10) Pub. No.: US 2025/0253554 A1
(43) Pub. Date: Aug. 7, 2025

(54) CONNECTION MECHANISM AND CONNECTION METHOD

(71) Applicant: Sumitomo Wiring Systems, Ltd., Yokkaichi-Shi, Mie (JP)

(72) Inventor: Hideki GOTO, Yokkaichi-Shi, Mie (JP)

(73) Assignee: Sumitomo Wiring Systems, Ltd., Yokkaichi-Shi, Mie (JP)

(21) Appl. No.: 18/856,304

(22) PCT Filed: Apr. 17, 2023
(86) PCT No.: PCT/JP2023/015324

§ 371 Date: Oct. 11, 2024

(30) Foreign Application Priority Data
Apr. 18, 2022 (JP) 2022-068323

(51) Int. Cl. H01R 4/58; H01R 4/18

(52) U.S. Cl. CPC H01R 4/58; H01R 4/183

(57) ABSTRACT

A connection mechanism for connecting a bus bar and a conductive wire member, including a connecting portion provided in the bus bar and configured to connect to the conductive wire member fitted thereinto, wherein the conductive wire member is in pressure contact with the connecting portion so that the bus bar and the conductive wire member are electrically connected.

### CROSS-REFERENCE TO RELATED APPLICATIONS

This application is the U.S. national stage of PCT/JP2023/015324 filed on Apr. 17, 2023, which claims priority of Japanese Patent Application No. JP 2022-068323 filed on Apr. 18, 2022, the contents of which are incorporated herein.

### TECHNICAL FIELD

The present disclosure relates to a connection mechanism and a connection method for connecting a bus bar and a conductive wire member.

### BACKGROUND

Conventionally, circuits using a bus bar in order to carry a relatively large current are mounted in vehicles. In recent years, as the functions of vehicles have expanded, the value of the current flowing through the bus bar has also been increasing.

JP 2014-79093A discloses a power supply device that includes a relay having a contact that can be opened and closed, and an excitation coil that switches between the open and closed states of the contact, in which the contact of the relay is electrically connected to a bus bar and the bus bar includes a heat dissipation mechanism, thereby enabling the bus bar to function as both a current path and a heat dissipation path.

When connecting a conductive wire member such as a wire harness to the bus bar described above, a special method such as ultrasonic welding or a method of attaching a separate metal fitting to the leading end of the conductive wire member and screwing the metal fitting to the bus bar is generally used, for example.

Such methods either require special equipment or increase the number of process steps, leading to higher production costs. However, the power supply device according to JP 2014-79093A does not consider such problems and cannot solve them.

Therefore, the present disclosure aims to provide a connection mechanism and a connection method for connecting a bus bar and a conductive wire member more simply and at lower cost.

### SUMMARY

A connection mechanism according to an embodiment of the present disclosure is a connection mechanism for connecting a bus bar and a conductive wire member, including: a connecting portion provided in the bus bar and configured to connect to the conductive wire member fitted thereinto, wherein the conductive wire member is in pressure contact with the connecting portion.

A connection method according to an embodiment of the present disclosure is a connection method for connecting a bus bar and a conductive wire member, including: inserting an end portion of the conductive wire member into a connecting portion that is provided in the bus bar and into which the conductive wire member is to be fitted, and applying pressure treatment to the connecting portion to deform the connecting portion and bring the conductive wire member into pressure contact with the connecting portion.

### Advantageous Effects

The present disclosure can provide a connection mechanism and a connection method for connecting a bus bar and a conductive wire member more simply and at lower cost.

### BRIEF DESCRIPTION OF DRAWINGS

FIG. 1 is a partial perspective view showing an example of a connection mechanism according to a first embodiment.

FIG. 2 is a partial cross-sectional view showing a connected state of a conductive wire member and a bus bar in the connection mechanism.

FIG. 3 is a cross-sectional view taken along a line III-III in FIG. 1.

FIG. 4 is a diagram illustrating a connection method according to the first embodiment.

FIG. 5 is a partial cross-sectional view showing a modification of the connection mechanism according to the first embodiment.

FIG. 6 is a partial perspective view showing an example of a connection mechanism according to a second embodiment.

FIG. 7 is a cross-sectional view taken along a line VII-VII in FIG. 6.

FIG. 8 is a cross-sectional view taken along a line VIII-VIII in FIG. 6.

FIG. 9 is a diagram illustrating a connection method according to the second embodiment.

FIG. 10 is a partial perspective view showing an example of a connection mechanism according to a third embodiment.

FIG. 11 is a cross-sectional view taken along a line XI-XI in FIG. 10.

FIG. 12 is a diagram illustrating a connection method according to the third embodiment.

FIG. 13 is a partial perspective view showing a modification of the connection mechanism according to the third embodiment.

### DETAILED DESCRIPTION OF PREFERRED EMBODIMENTS

First, embodiments of the present disclosure will be listed and described. At least some of the embodiments described below may be combined in any manner.

A connection mechanism according to an embodiment of the present disclosure is a connection mechanism for connecting a bus bar and a conductive wire member, including: a connecting portion provided in the bus bar and configured to connect to the conductive wire member fitted thereinto, wherein the conductive wire member is in pressure contact with the connecting portion.

According to this embodiment, the connecting portion is fitted on the conductive wire member and is in pressure contact therewith, and therefore the connecting portion and the conductive wire member can be reliably connected.

In the connection mechanism according to an embodiment of the present disclosure, the connecting portion has a tubular shape projecting from one side of the bus bar, and the connecting portion has an insertion hole into which the conductive wire member is inserted from the other side of the bus bar.

According to this embodiment, the conductive wire member is inserted into the insertion hole of the connecting portion, and the connecting portion is fitted on the conductive wire member and is in pressure contact therewith. Therefore, the connecting portion and the conductive wire member can be reliably connected.

In the connection mechanism according to an embodiment of the present disclosure, the connecting portion has a wall thickness that decreases toward its projecting end.

According to this embodiment, the connecting portion has a wall thickness decreasing toward its projecting end, and therefore, when the connecting portion is to be deformed and brought into pressure contact with the conductive wire member, the connecting portion can be easily deformed by, for example, mechanical pressure treatment or the like.

In the connection mechanism according to an embodiment of the present disclosure, the connecting portion has a cylindrical shape, and a leading end side of the connecting portion is closed by a lid portion.

According to this embodiment, the connecting portion has a cylindrical shape, and a leading end side of the connecting portion is closed by a lid portion. Therefore, when, for example, mechanical pressure treatment is applied to deform the connecting portion and bring it into pressure contact with the conductive wire member, the contact area between the connecting portion and the conductive wire member can be increased.

In the connection mechanism according to an embodiment of the present disclosure, the connecting portion has a recessed portion at at least one position on its outer surface that is recessed toward the conductive wire member disposed inside the connecting portion.

According to this embodiment, the connecting portion can be deformed by, for example, applying mechanical pressure treatment or the like to form the recessed portion, so that the connecting portion and the conductive wire member can be brought into pressure contact.

In the connection mechanism according to an embodiment of the present disclosure, the connecting portion: is provided in a rectangular portion of the bus bar, and includes: a first curved portion that is a portion between two cuts extending in a length direction of the rectangular portion, and is curved toward one side in a thickness direction of the bus bar; a cutout formed between one cut of the two cuts and an end portion of the rectangular portion with respect to a width direction of the bus bar; and a second curved portion that is a portion between the one cut and the cutout and is curved toward another side in the thickness direction of the bus bar, and the conductive wire member is passed on the inner side of the first curved portion and the second curved portion in the width direction of the rectangular portion, and is in pressure contact with the first curved portion and the second curved portion.

According to this embodiment, the conductive wire member passes inside the first curved portion and the second curved portion and is in pressure contact with the first curved portion and the second curved portion. Therefore, the connecting portion and the conductive wire member can be reliably connected.

In the connection mechanism according to an embodiment of the present disclosure, the second curved portion is provided as two second curved portions on both sides of the first curved portion in the width direction of the rectangular portion, and the first curved portion has a greater width than the second curved portions.

According to this embodiment, the second curved portion is provided as two second curved portions on two sides of the first curved portion, and the first curved portion has a greater width than the second curved portions. Therefore, the connecting portion and the conductive wire member can be more reliably connected.

In the connection mechanism according to an embodiment of the present disclosure, the end portion is curved toward the other side in the thickness direction of the bus bar.

In the embodiment, the end portion of the rectangular portion of the bus bar is curved in the thickness direction of the bus bar, and therefore, the work of passing the conductive wire member inside the first curved portion and the second curved portion in the width direction of the rectangular portion can be easily performed.

In the connection mechanism according to an embodiment of the present disclosure, the connecting portion: is provided in a rectangular portion of the bus bar, and includes a third curved portion that is a portion between two cutouts formed to extend in a length direction of the rectangular portion at a distance from each other in a width direction of the rectangular portion, and is curved toward one side of the bus bar in a thickness direction of the bus bar, and the conductive wire member: is passed on the inner side of the third curved portion in the width direction of the rectangular portion, and is in pressure contact with the third curved portion.

According to this embodiment, the conductive wire member passes inside the third curved portion and is in pressure contact with the third curved portion. Therefore, the connecting portion and the conductive wire member can be reliably connected.

In the connection mechanism according to an embodiment of the present disclosure, another cutout extending in a length direction of the rectangular portion is formed in an intermediate portion of the third curved portion in the width direction of the rectangular portion.

In this embodiment, the other cutout is formed in an intermediate portion of the third curved portion in the width direction of the rectangular portion. In other words, the third curved portion is divided into two portions by the other cutout in the width direction of the rectangular portion. Therefore, each portion of the third curved portion can be easily deformed, for example, by mechanical pressure treatment or the like, to be in pressure contact with the conductive wire member.

A connection method according to an embodiment of the present disclosure is a connection method for connecting a bus bar and a conductive wire member, including: inserting an end portion of the conductive wire member into a connecting portion that is provided in the bus bar and into which the conductive wire member is to be fitted, and applying pressure treatment to the connecting portion to deform the connecting portion and bring the conductive wire member into pressure contact with the connecting portion.

According to this embodiment, pressure treatment is applied to deform the connecting portion, and the connecting portion and the conductive wire member are brought into pressure contact, and therefore the connecting portion and the conductive wire member can be reliably connected.

Hereinafter, a connection mechanism and a connection method according to an embodiment of the present disclosure will be described with reference to the drawings. Note that the present disclosure is not limited to these examples, but is defined by the scope of the claims, and is intended to include all modifications within the meaning and scope of the claims.

### First Embodiment

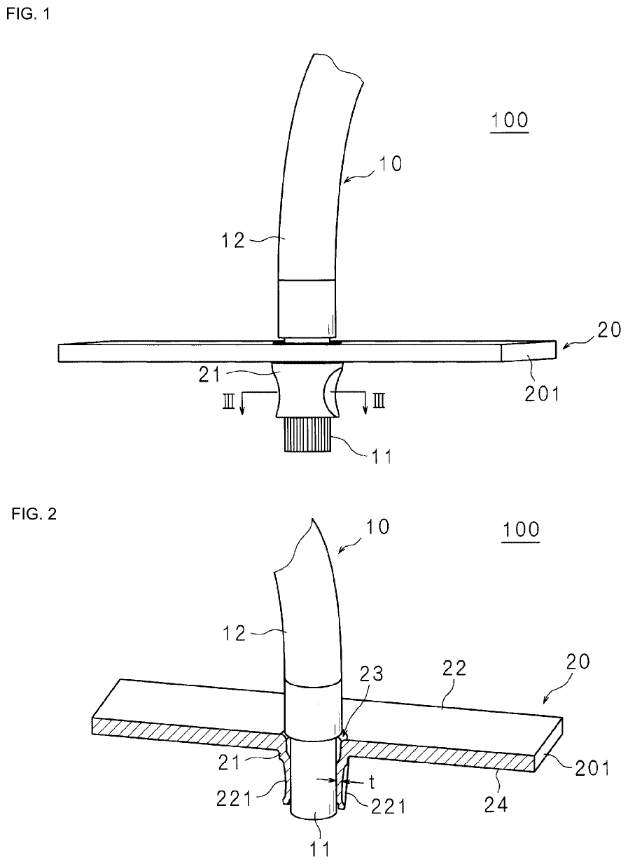

Hereinafter, embodiments will be described with reference to the drawings. FIG. 1 is a partial perspective view showing an example of a connection mechanism 100 according to a first embodiment. The connection mechanism 100 includes a bus bar 20 and a conductive wire member 10. That is to say, the connection mechanism 100 is a connection mechanism for connecting the conductive wire member 10 and the bus bar 20, and one end portion of the conductive wire member 10 is connected to the bus bar 20. For convenience, only one end portion of the conductive wire member 10 is shown in FIG. 1.

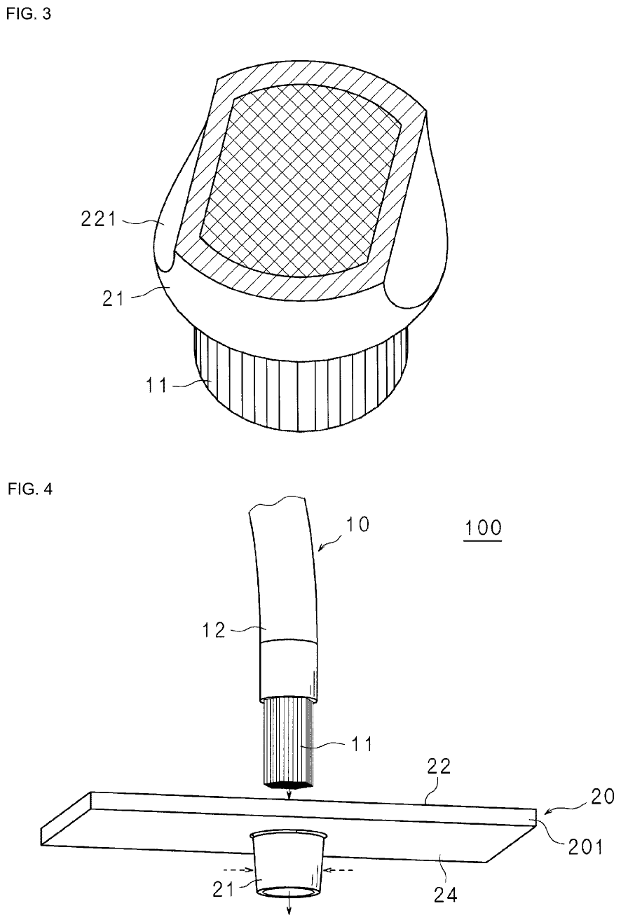

FIG. 2 is a partial cross-sectional view showing a connected state of the conductive wire member 10 and the bus bar 20 in the connection mechanism 100, and FIG. 3 is a cross-sectional view taken along the line III-III in FIG. 1.

In the conductive wire member 10, for example, a conductor portion constituted by a plurality of thin copper wires is covered by an insulating portion 12, and a leading end portion 11 of the conductor portion from which the insulating portion 12 is removed is electrically connected to the bus bar 20. In the following description, the depiction of the thin copper wires in the conductive wire member 10 may be omitted for the sake of simplicity.

The bus bar 20 is made of a conductive metal such as copper and includes a rectangular plate portion 201 having a rectangular plate shape. The rectangular plate portion 201 of the bus bar 20 has a connecting portion 21 connected to the leading end portion 11 of the conductive wire member 10. The connecting portion 21 projects from one side 24 of the rectangular plate portion 201. The connecting portion 21 has, for example, a cylindrical shape with an inner diameter slightly larger than the outer diameter of the leading end portion 11 of the conductive wire member 10, and both ends in its axial length direction are open. That is to say, a communication hole 23 (insertion hole) that communicates with the inside of the connecting portion 21 is formed in the other side 22 of the rectangular plate portion 201. For example, the connecting portion 21 is formed by applying a so-called drawing process to the bus bar 20. The leading end portion 11 of the conductive wire member 10 is inserted into the connecting portion 21 from the other side 22 of the rectangular plate portion 201.

The connecting portion 21 has a substantially constant inner diameter along its axial length direction. On the other hand, the outer diameter of the connecting portion 21 gradually decreases toward its protruding end. That is to say, a wall thickness t of the connecting portion 21 decreases toward the end of the protrusion (see FIG. 2).

As will be described later, a pair or two pairs of dented portions 221 (recessed portions) formed by a mechanical pressure treatment are provided on the outer circumferential surface of the connecting portion 21 at intermediate positions with respect to its axial length direction. The dented portions 221 of each pair are provided at positions opposite to each other in a radial direction of the connecting portion 21. The dented portions 221 are recessed toward the inside of the connecting portion 21, i.e., toward the leading end portion 11 of the conductive wire member 10 inside the connecting portion 21. The following describes an example in which a pair of dented portions 221 is provided on the outer circumferential surface of the connecting portion 21.

As shown in FIGS. 2 and 3, in the connecting portion 21, the areas where the dented portions 221 are provided are significantly deformed by the mechanical pressure treatment. Therefore, the portions of the inner circumferential surface of the connecting portion 21 corresponding to the dented portions 221 are forcibly brought into pressure contact with the leading end portion 11 of the conductive wire member 10. Therefore, the electrical connection between the leading end portion 11 of the conductive wire member 10 and the connecting portion 21 of the rectangular plate portion 201 is ensured.

FIG. 4 is a diagram illustrating a connection method according to the first embodiment.

First, the bus bar 20 and the conductive wire member 10 are prepared. At this time, the insulating portion 12 has been removed from the leading end portion 11 of the conductive wire member 10, and the dented portions 221 have not yet been provided in the connecting portion 21 of the rectangular plate portion 201.

The worker inserts the leading end portion 11 of the conductive wire member 10 into the connecting portion 21 from the other side 22 of the rectangular plate portion 201 in the thickness direction of the rectangular plate portion 201 (see the solid arrows in FIG. 4). Next, the worker uses, for example, a press to clamp the outer circumferential surface of the connecting portion 21 at positions opposite to each other in a radial direction, and applies mechanical pressure (see the dotted arrows in FIG. 4). By this mechanical pressure treatment, the connecting portion 21 is deformed to form the pair of dented portions 221. At this time, as described above, the portions of the connecting portion 21 corresponding to the dented portions 221 are deformed and forcibly brought into pressure contact with the leading end portion 11 of the conductive wire member 10, and therefore the electrical connection between the leading end portion 11 of the conductive wire member 10 and the connecting portion 21 of the rectangular plate portion 201 can be ensured.

### Modifications

With respect to the connection mechanism 100 according to the first embodiment, although the above description illustrates an example in which both ends of the connecting portion 21 in its axial length direction are open, the present disclosure is not limited to such an example. For example, the connecting portion 21 may have a cylindrical shape with a bottom.

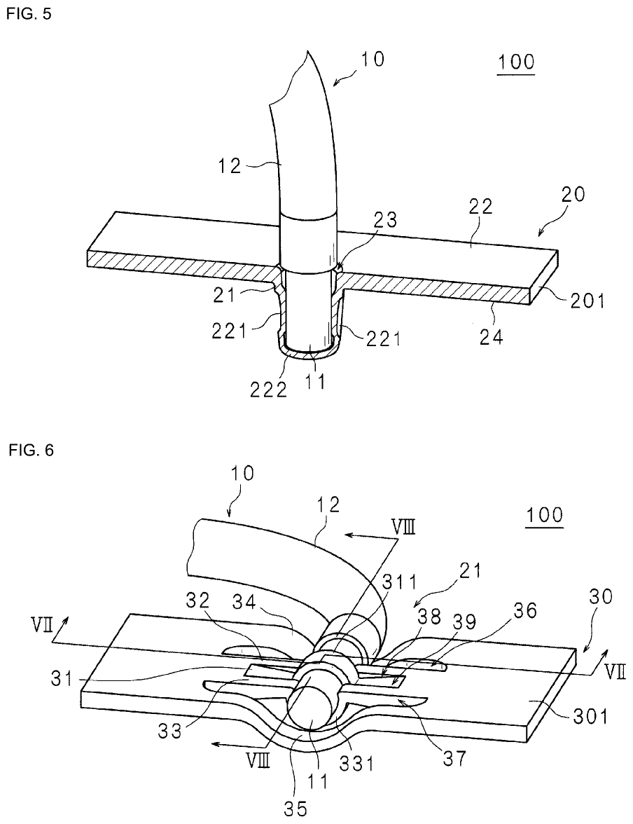

FIG. 5 is a partial cross-sectional view showing a modification of the connection mechanism 100 according to the first embodiment. As shown in FIG. 5, in the connection mechanism 100 according to the modification, the connecting portion 21 of the bus bar 20 has a lid portion 222 on the projecting leading end side. That is to say, the end portion on the projecting leading end side of the connecting portion 21 is closed by the lid portion 222. The leading end portion 11 of the conductive wire member 10 is housed in the connecting portion 21.

Therefore, in the connection mechanism 100 according to the modification, the portions of the connecting portion 21 corresponding to the dented portions 221 are forcibly brought into pressure contact with the leading end portion 11 of the conductive wire member 10, and the lid portion 222 of the connecting portion 21 is also brought into contact with the leading end portion 11 of the conductive wire member 10. Therefore, the connection area between the leading end portion 11 of the conductive wire member 10 and the connecting portion 21 of the bus bar 20 can be increased.

It goes without saying that the connection mechanism 100 according to the present modification also provides the same effects as the connection mechanism 100 according to the first embodiment.

With the above-described configuration, the connection mechanism 100 can ensure the connection between the conductive wire member 10 and the bus bar 20 simply and at low cost, without any additional metal fittings attached to the conductive wire member 10, and without using a special technique such as ultrasonic welding.

In the connection mechanism 100 according to the first embodiment, as described above, the connecting portion 21 is cylindrical and therefore the mechanical pressure treatment for forming the dented portions 221 can be easily performed.

In the connection mechanism 100 according to the first embodiment, as described above, the wall thickness t of the connecting portion 21 decreases toward the end of the protrusion (see FIG. 2), and therefore when dented portions 221 are formed by mechanical pressure treatment, the connecting portion 21 can be easily deformed, and the connection between the leading end portion 11 of the conductive wire member 10 and the connecting portion 21 of the bus bar 20 can be reliably ensured.

Although the above description illustrates examples in which the connecting portion 21 is cylindrical, the present disclosure is not limited to such examples, and the connecting portion 21 may also be an angular tube such as a triangular tube.

Although the above description illustrates an example in which the leading end portion 11 from which the insulating portion 12 is removed is provided at one end portion of the conductive wire member 10 and the leading end portion 11 at the one end portion is electrically connected to the connecting portion 21 of the bus bar 20, the present disclosure is not limited to such an example. For example, it is also possible to adopt a configuration in which another leading end portion 11 is also provided at the other end of the conductive wire member 10, and the leading end portion 11 at the other end is electrically connected to the connecting portion 21 of another bus bar 20.

Although the above description illustrates examples of the connection mechanism 100 according to the first embodiment in which a pair or pairs of dented portions 221 are provided on the outer circumferential surface of the connecting portion 21, the present disclosure is not limited to such examples. A dented portion 221 may also be provided at only one position on the outer circumferential surface of the connecting portion 21.

### Second Embodiment

FIG. 6 is a partial perspective view showing an example of a connection mechanism 100 according to a second embodiment. The connection mechanism 100 is a connection mechanism for connecting the conductive wire member 10 and a bus bar 30, and one end portion of the conductive wire member 10 is connected to the bus bar 30. For convenience, only one end portion of the conductive wire member 10 is shown in FIG. 6.

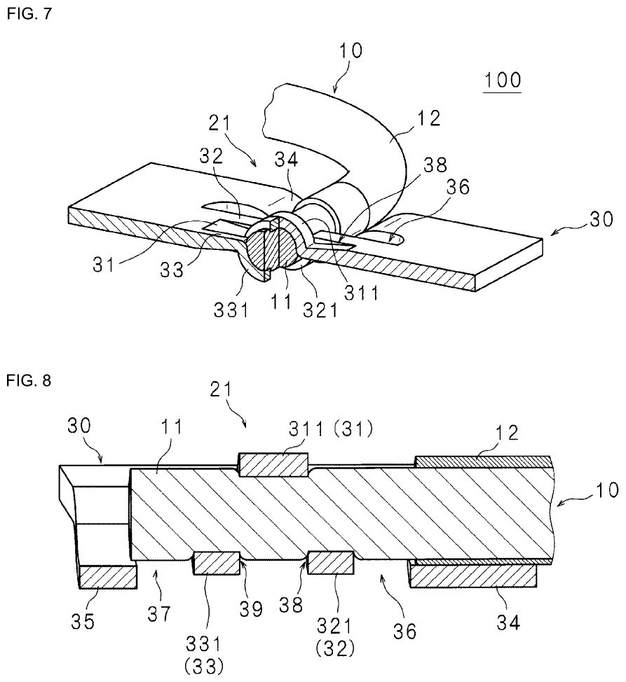

FIG. 7 is a cross-sectional view taken along a line VII-VII in FIG. 6, and FIG. 8 is a cross-sectional view taken along a line VIII-VIII in FIG. 6.

In the conductive wire member 10, for example, a conductor portion constituted by a plurality of thin copper wires is covered by an insulating portion 12, and a leading end portion 11 of the conductor portion from which the insulating portion 12 is removed is electrically connected to the bus bar 30.

The bus bar 30 is made of a conductive metal such as copper and includes a rectangular plate portion 301 having a rectangular plate shape. The rectangular plate portion 301 is provided with a connecting portion 21. The following describes the configuration of the connecting portion 21.

The rectangular plate portion 301 of the bus bar 30 has two cuts 38 and 39 extending in the length direction of the bus bar 30 in an intermediate portion with respect to its width direction. The two cuts 38 and 39 have the same length and are formed at a predetermined distance from each other in the width direction of the rectangular plate portion 301.

A first contact portion 31 (first curved portion), which is a portion between the two cuts 38 and 39 and is in contact with an intermediate section of the leading end portion 11 of the conductive wire member 10, is curved toward one side in the thickness direction of the rectangular plate portion 301 at an intermediate portion of the rectangular plate portion 301 with respect to its length direction, forming a curved portion 311.

A cutout 36 that extends in the length direction of the rectangular plate portion 301 is formed between the cut 38 and one end portion 34 of the rectangular plate portion 301 in the width direction. The length of the cutout 36 is greater than the length of the cut 38. A second contact portion 32 (second curved portion), which is a portion between the cut 38 and the cutout 36 and is in contact with a base end section of the leading end portion 11 of the conductive wire member 10, is curved toward the other side in the thickness direction of the rectangular plate portion 301 at an intermediate portion of the rectangular plate portion 301 with respect to its length direction, forming a curved portion 321.

In addition, a cutout 37 that extends in the length direction of the rectangular plate portion 301 is formed between the cut 39 and the other end portion 35 of the rectangular plate portion 301 in its width direction. The length of the cutout 37 is greater than the length of the cut 39. A third contact portion 33 (second curved portion), which is a portion between the cut 39 and the cutout 37 and is in contact with a leading end section of the leading end portion 11 of the conductive wire member 10, is curved toward the other side in the thickness direction of the rectangular plate portion 301 at an intermediate portion of the rectangular plate portion 301 in its length direction, as with the second contact portion 32, forming a curved portion 331.

With respect to the dimensions of the second contact portion 32, the first contact portion 31, and the third contact portion 33 in the width direction of the rectangular plate portion 301, the first contact portion 31 is larger than the second contact portion 32 and the third contact portion 33.

The leading end portion 11 of the conductive wire member 10 passes along the inner side of the curved portion 321 of the second contact portion 32, the inner side of the curved portion 311 of the first contact portion 31, and the inner side of the curved portion 331 of the third contact portion 33.

By the mechanical pressure treatment described below, the curved portion 311 of the first contact portion 31, the curved portion 321 of the second contact portion 32, and the curved portion 331 of the third contact portion 33 are curved along the outer circumferential surface of the leading end portion 11 of the conductive wire member 10, and are forcibly brought into pressure contact with the leading end portion 11 of the conductive wire member 10.

Specifically, the second contact portion 32 is in contact with the base end section of the leading end portion 11 of the conductive wire member 10, the first contact portion 31 is in contact with the intermediate section of the leading end portion 11 of the conductive wire member 10, and the third contact portion 33 is in contact with the leading end section of the leading end portion 11 of the conductive wire member 10 (see FIG. 8).

In addition, as described above, the curved portion 321 of the second contact portion 32 and the curved portion 331 of the third contact portion 33, and the curved portion 311 of the first contact portion 31, are curved in opposite directions to each other and are in contact with the leading end portion 11 of the conductive wire member 10 from opposite sides in the thickness direction of the rectangular plate portion 301.

Note that, just like the second contact portion 32, the one end portion 34 of the rectangular plate portion 301 in its width direction is curved toward the other side of the rectangular plate portion 301 in the thickness direction. In addition, just like the third contact portion 33, the other end portion 35 of the rectangular plate portion 301 in its width direction is curved toward the other side of the rectangular plate portion 301 in the thickness direction.

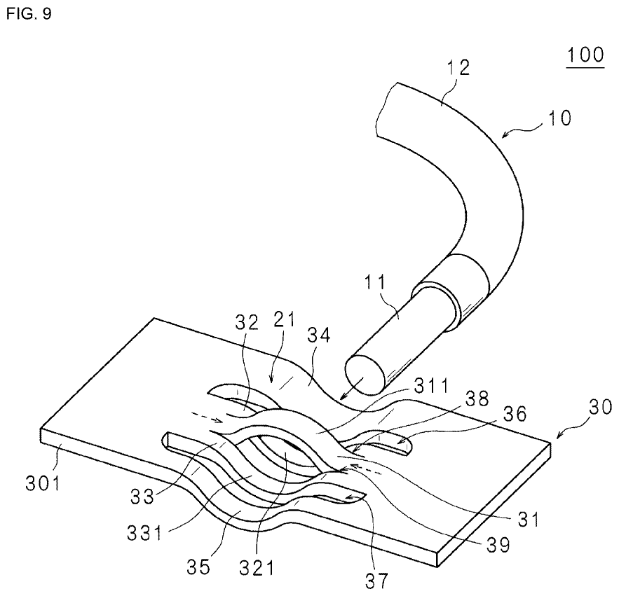

FIG. 9 is a diagram illustrating a connection method according to the second embodiment.

First, the bus bar 30 and the conductive wire member 10 are prepared. At this time, the insulating portion 12 has been removed from the leading end portion 11 of the conductive wire member 10.

The worker passes the leading end portion 11 of the conductive wire member 10 through, for example, the region on the inner side of the curved portion 321 of the second contact portion 32, the region on the inner side of the curved portion 311 of the first contact portion 31, and the region on the inner side of the curved portion 331 of the third contact portion 33 in this order (see the solid arrow in FIG. 9). At this time, the leading end portion 11 of the conductive wire member 10 may be inserted from the one end portion 34 side or the other end portion 35 side of the rectangular plate portion 301.

In such a situation, the worker uses, for example, a press to apply mechanical pressure from both sides in the longitudinal direction of the rectangular plate portion 301, from the outside of the second contact portion 32, the first contact portion 31, and the third contact portion 33, toward the leading end portion 11 of the conductive wire member 10 (see the dotted arrows in FIG. 9). By this mechanical pressure treatment, the curved portion 321 of the second contact portion 32, the curved portion 311 of the first contact portion 31, and the curved portion 331 of the third contact portion 33 are deformed. As described above, the curved portion 321, the curved portion 311, and the curved portion 331 are curved along the outer circumferential surface of the leading end portion 11 of the conductive wire member 10 to fit on the leading end portion 11 of the conductive wire member 10. Therefore, the second contact portion 32, the first contact portion 31, and the third contact portion 33 are forcibly brought into pressure contact with the leading end portion 11 of the conductive wire member 10 to ensure the electrical connection between the bus bar 30 and the leading end portion 11 of the conductive wire member 10.

Since the connecting portion 21 has the above-described configuration, the connection mechanism 100 according to the second embodiment can ensure the connection between the conductive wire member 10 and the bus bar 30 simply and at low cost, without any additional metal fittings attached to the conductive wire member 10, and without using any special technique such as ultrasonic welding.

As described above, in the connection mechanism 100 according to the second embodiment, the one end portion 34 of the rectangular plate portion 301 in the width direction, and the other end portion 35 of the rectangular plate portion 301 in the width direction are both curved toward the other side in the thickness direction of the rectangular plate portion 301. Such a configuration facilitates the insertion work performed to pass the leading end portion 11 of the conductive wire member 10 through the region on the inner side of the second contact portion 32, the region on the inner side of the first contact portion 31, and the region on the inner side of the third contact portion 33, eliminates restrictions on the insertion direction, and increases the freedom of work.

With respect to the connection mechanism 100 according to the second embodiment, although the above description illustrates an example in which the second contact portion 32 and the third contact portion 33 are respectively provided on both sides of the first contact portion 31, the present disclosure is not limited to such an example. It is only possible that only one of the second contact portion 32 and the third contact portion 33 is provided.

Components that are the same as those in the first embodiment are given the same reference numerals and their further detailed descriptions are omitted.

### Third Embodiment

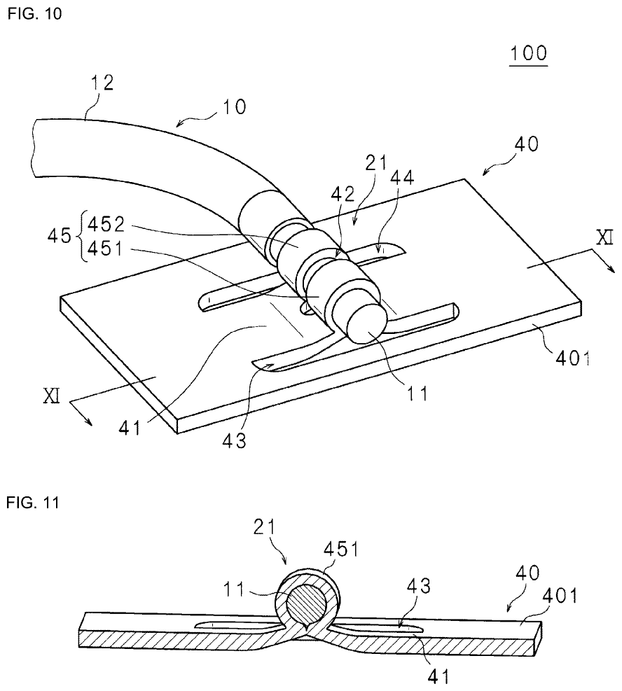

FIG. 10 is a partial perspective view showing an example of a connection mechanism 100 according to a third embodiment, and FIG. 11 is a cross-sectional view taken along a line XI-XI in FIG. 10.

The connection mechanism 100 is a connection mechanism for connecting the conductive wire member 10 and a bus bar 40, and one end portion of the conductive wire member 10 is connected to the bus bar 40. For convenience, only one end portion of the conductive wire member 10 is shown in FIG. 10.

In the conductive wire member 10, for example, a conductor portion constituted by a plurality of thin copper wires, is covered by an insulating portion 12, and a leading end portion 11 of the conductor portion from which the insulating portion 12 is removed is electrically connected to the bus bar 40.

The bus bar 40 is made of a conductive metal such as copper and includes a rectangular plate portion 401 having a rectangular plate shape. The rectangular plate portion 401 is provided with a connecting portion 21. The following describes the configuration of the connecting portion 21.

The rectangular plate portion 401 of the bus bar 40 has two cutouts 43 and 44 extending in the length direction of the bus bar 40 near the two end portions in the width direction. The two cutouts 43 and 44 have the same length and are formed at a predetermined distance from each other in the width direction of the rectangular plate portion 401.

A fourth contact portion 41 (third curved portion), which is a portion between the two cutouts 43 and 44 and is in contact with the leading end portion 11 of the conductive wire member 10, is curved toward one side in the thickness direction of the rectangular plate portion 401 at an intermediate portion of the rectangular plate portion 401 with respect to its length direction, forming a curved portion 45.

A cutout 42 extending in the longitudinal direction of the rectangular plate portion 401 is formed in an intermediate portion of the curved portion 45 with respect to the width direction of the rectangular plate portion 401. The curved portion 45 is divided by the cutout 42 into two portions, namely a curved portion 452 that is in contact with a base end section of the leading end portion 11 of the conductive wire member 10 and a curved portion 451 that is in contact with a leading end section of the leading end portion 11 of the conductive wire member 10.

The leading end portion 11 of the conductive wire member 10 passes on the inner side of the curved portion 451 of the fourth contact portion 41 and on the inner side of the curved portion 452 of the fourth contact portion 41. By the mechanical pressure treatment described below, the curved portion 451 and the curved portion 452 are curved along the outer circumferential surface of the leading end portion 11 of the conductive wire member 10, and are forcibly brought into pressure contact with the leading end portion 11 of the conductive wire member 10.

Specifically, as shown in FIG. 11, the curved portion 451 and the curved portion 452 are each formed into a substantially circular shape and fitted on the leading end portion 11 of the conductive wire member 10. The curved portion 452 is in contact with the base end section of the leading end portion 11 of the conductive wire member 10, and the curved portion 451 is in contact with the leading end section of the leading end portion 11 of the conductive wire member 10 (see FIG. 10).

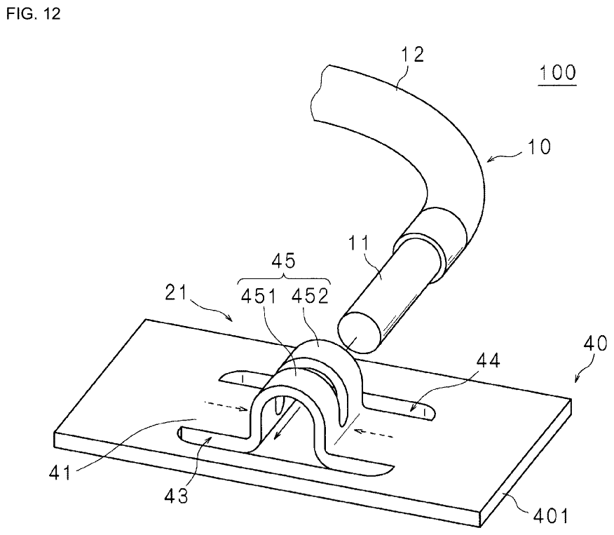

FIG. 12 is a diagram illustrating a connection method according to the third embodiment.

First, the bus bar 40 and the conductive wire member 10 are prepared. At this time, the insulating portion 12 has been removed from the leading end portion 11 of the conductive wire member 10, and neither of the curved portion 451 and the curved portion 452 has yet been formed into a circular shape, but has an inverted U-shape.

The worker passes the leading end portion 11 of the conductive wire member 10 through, for example, the region on the inner side of the curved portion 452 of the fourth contact portion 41 and the region on the inner side of the curved portion 451 of the fourth contact portion 41 in this order (see the solid arrow in FIG. 12). At this time, the leading end portion 11 of the conductive wire member may be inserted from the curved portion 451 side or the curved portion 452 side of the rectangular plate portion 401.

In this situation, the worker uses, for example, a press to apply mechanical pressure from both sides in the longitudinal direction of the rectangular plate portion 401, from the outside of the fourth contact portion 41 (the curved portion 451 and the curved portion 452), toward the leading end portion 11 of the conductive wire member 10 (see the dotted arrows in FIG. 12). By this mechanical pressure treatment, the curved portion 451 and the curved portion 452 of the fourth contact portion 41 are deformed. As described above, the curved portion 451 and the curved portion 452 are curved in a substantially circular shape along the outer circumferential surface of the leading end portion 11 of the conductive wire member 10 to fit on the leading end portion 11 of the conductive wire member 10. Therefore, the curved portion 451 and the curved portion 452 are forcibly brought into pressure contact with the leading end portion 11 of the conductive wire member 10 to ensure the electrical connection between the bus bar 40 and the leading end portion 11 of the conductive wire member 10.

Since the connecting portion 21 has the above-described configuration, the connection mechanism 100 according to the third embodiment can ensure the connection between the conductive wire member 10 and the bus bar 40 simply and at low cost, without any additional metal fittings attached to the conductive wire member 10, and without using any special technique such as ultrasonic welding.

In the connection mechanism 100 according to the third embodiment, as described above, the curved portion 45 is divided by the cutout 42 into two portions, namely the curved portion 452 and the curved portion 451, and therefore, when mechanical pressure treatment is applied, the curved portion 45 can be easily deformed, and the connection between the leading end portion 11 of the conductive wire member 10 and the curved portion 45 of the bus bar 40 can be reliably ensured.

### Modifications

With respect to the connection mechanism 100 according to the third embodiment, although the above description illustrates an example in which the curved portion 45 is divided by the cutout 42 into two portions, namely the curved portion 452 and the curved portion 451, the present disclosure is not limited to such an example.

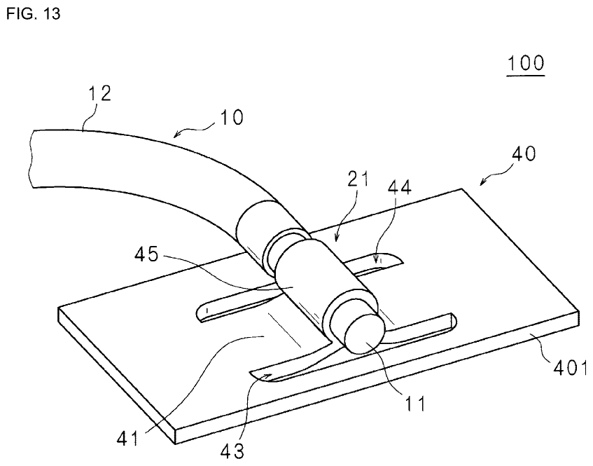

FIG. 13 is a partial perspective view showing a modification of the connection mechanism 100 according to the third embodiment. As shown in FIG. 13, in the connection mechanism 100 according to the modification, no cutout is formed in the curved portion 45, and the curved portion 45 is not divided into two portions.

In the connection mechanism 100 according to the present modification, the shape of the bus bar 40 (the rectangular plate portion 401) is simplified and therefore the manufacturing cost of the bus bar 40 can be reduced.

It goes without saying that the connection mechanism 100 according to the present modification also provides the same effects as the connection mechanism 100 according to the third embodiment.

The same components as those in the first embodiment are given the same reference numerals and detailed descriptions are omitted.

The technical features (constituent elements) described in the first to third embodiments can be combined with each other, and new technical features can be formed by combining them.

The embodiments disclosed herein should be considered to be illustrative and not restrictive in all respects. The scope of the present disclosure is defined by the claims, not by the meaning described above, and is intended to include all modifications within the meaning and scope of the claims.

The matters described in each embodiment can be combined with each other. In addition, the independent claims and dependent claims in the appended claims may be combined in any combination, regardless of their form of reference. Furthermore, although the appended claims are written in a format in which one claim refers to two or more other claims (multiple dependent claim format), the claims are not limited to such a format. Claims may also be written in a format in which one multiple dependent claim refers to one or more other multiple dependent claims (multi-multi dependent claim).

1. A connection mechanism for connecting a bus bar and a conductive wire member, comprising:
a connecting portion provided in the bus bar and configured to connect to the conductive wire member fitted thereinto,
wherein the conductive wire member is in pressure contact with the connecting portion.

2. The connection mechanism according to claim 1,
wherein the connecting portion has a tubular shape projecting from one side of the bus bar, and
the connecting portion has an insertion hole into which the conductive wire member is inserted from the other side of the bus bar.

3. The connection mechanism according to claim 2, wherein the connecting portion has a wall thickness that decreases toward its projecting end.

4. The connection mechanism according to claim 3,
wherein the connecting portion
has a cylindrical shape, and
a leading end side of the connecting portion is closed by a lid portion.

5. The connection mechanism according to claim 2, wherein the connecting portion has a recessed portion at at least one position on its outer surface that is recessed toward the conductive wire member disposed inside the connecting portion.

6. The connection mechanism according to claim 1,
wherein the connecting portion:
is provided in a rectangular portion of the bus bar, and includes:
a first curved portion that is a portion between two cuts extending in a length direction of the rectangular portion, and is curved toward one side in a thickness direction of the bus bar;
a cutout formed between one cut of the two cuts and an end portion of the rectangular portion with respect to a width direction of the bus bar; and
a second curved portion that is a portion between the one cut and the cutout and is curved toward another side in the thickness direction of the bus bar, and
the conductive wire member
is passed on the inner side of the first curved portion and the second curved portion in the width direction of the rectangular portion, and
is in pressure contact with the first curved portion and the second curved portion.

7. The connection mechanism according to claim 6,
wherein the second curved portion is provided as two second curved portions on both sides of the first curved portion in the width direction of the rectangular portions, and
the first curved portion has a greater width than the second curved portions.

8. The connection mechanism according to claim 6, wherein the end portion is curved toward the other side in the thickness direction of the bus bar.

9. The connection mechanism according to claim 1,
wherein the connecting portion:
is provided in a rectangular portion of the bus bar, and
includes a third curved portion that is a portion between two cutouts formed to extend in a length direction of the rectangular portion at a distance from each other in a width direction of the rectangular portion, and is curved toward one side of the bus bar in a thickness direction of the bus bar, and
the conductive wire member:
is passed on the inner side of the third curved portion in the width direction of the rectangular portion, and
is in pressure contact with the third curved portion.

10. The connection mechanism according to claim 9, wherein another cutout extending in a length direction of the rectangular portion is formed in an intermediate portion of the third curved portion in the width direction of the rectangular portion.

11. A connection method for connecting a bus bar and a conductive wire member, comprising:
inserting an end portion of the conductive wire member into a connecting portion that is provided in the bus bar and into which the conductive wire member is to be fitted, and
applying pressure treatment to the connecting portion to deform the connecting portion and bring the conductive wire member into pressure contact with the connecting portion.

12. The connection mechanism according to claim 3, wherein the connecting portion has a recessed portion at at least one position on its outer surface that is recessed toward the conductive wire member disposed inside the connecting portion.

13. The connection mechanism according to claim 4, wherein the connecting portion has a recessed portion at at least one position on its outer surface that is recessed toward the conductive wire member disposed inside the connecting portion.

14. The connection mechanism according to claim 7, wherein the end portion is curved toward the other side in the thickness direction of the bus bar.
